(19) United States
(12) Patent Application Publication
(10) Pub. No.: US 2025/0199232 A1
(43) Pub. Date: Jun. 19, 2025

(54) DIFFRACTIVE WAVEGUIDE HAVING NANOIMPRINT LITHOGRAPHY RESIN WITH NANOPARTICLES

(71) Applicant: GOOGLE LLC, Mountain View, CA (US)

(72) Inventor: Constantin-Christian A. Voll, San Francisco, CA (US)

(21) Appl. No.: 18/543,919

(22) Filed: Dec. 18, 2023

(51) Int. Cl. F21V 8/00; B82Y 20/00; G02B 5/20

(52) U.S. Cl. CPC G02B 6/0065; B82Y 20/00; G02B 5/208; G02B 6/0016; G02B 6/0036; G02B 2207/101

(57) ABSTRACT

A waveguide includes a transparent substrate having a nano imprint lithography NIL layer disposed at a working surface. The NIL layer includes a polymer resin layer having core-shell nanoparticles. This NIL layer serves as the foundation for implementing various optical features, such as diffractive elements that form an input coupler, an exit pupil expander, and/or an output coupler. The core-shell nanoparticles are composed of a metal core, primarily consisting of a first metal material. Additionally, a plurality of ligands are arranged on at least a portion of this metal core. Moreover, a metal shell may be disposed on the surface of the metal core. In this configuration, the metal core may be made from a second metal material. The polymer resin layer may include an ultraviolet (UV) light absorbing material, which further may contribute to its light stability.

### BACKGROUND

A waveguide-based optical combiner (“waveguide combiner”) often is used in augmented reality (AR)-based near-eye displays for providing a view of the real world overlayed with static imagery or video (recorded or rendered). Typically, such optical combiners employ an input coupler (IC) to receive display light, an optional exit pupil expander (EPE) to increase the size of the display exit pupil, and an output coupler (OC) to direct the resulting display light toward a user's eye. Conventional waveguide combiners typically implement a monolithic plastic substrate implementing an IC, EPE, and OC using the same base material.

Large-scale production of diffractive waveguides often relies on the use of nanoparticle-infused nano imprint lithography (NIL) resin. For example, in an ultraviolet (UV)-NIL process, diffractive optical elements are formed by applying a liquid NIL resin onto a substrate, which is then patterned and imprinted using a stamp, followed by UV curing. Substrates with high refractive indices (RI) may be associated with expanded field-of-view (FOV) and improved image quality. It typically is advantageous for the NIL resins to match the refractive index of the substrate to prevent Fresnel reflections at the interface between the resin and glass. Glass substrates may possess refractive indices exceeding 1.8. While many suitable NIL resins with high refractive indices, such as n>1.8, may include titanium dioxide nanoparticles and a polymeric binder, titanium dioxide is highly photoactive. Consequently, high RI NIL materials containing titanium dioxide nanoparticles exhibit poor light stability, particularly towards UV. Exposure to short-wavelength light such as UV and blue light may lead to undesirable effects such as transmission loss, changes in spectral transmission, increased haze, alterations in refractive index, and/or modifications in film thickness, to name a few. Many of these factors may adversely impact the functionality of the waveguide.

### BRIEF DESCRIPTION OF THE DRAWINGS

The present disclosure may be better understood, and its numerous features and advantages made apparent to those skilled in the art, by referencing the accompanying drawings. The use of the same reference symbols in different drawings indicates similar or identical items.

FIG. 1 is a diagram of a waveguide having an input coupler (IC) aligned with an optional exit pupil expander (EPE) formed at least partially at a nanoparticle-infused NIL material layer in accordance with some embodiments.

FIG. 2 is a diagram illustrating a nanoparticle of the nanoparticle-infused NIL material layer of FIG. 1 that is composed of a metal core and a plurality of ligands connected thereto in accordance with some embodiments.

FIG. 3 is a diagram illustrating a core-shell nanoparticle of the nanoparticle-infused NIL material layer of FIG. 1 that is composed of a metal core, a metal shell, and a plurality of ligands connected thereto in accordance with some embodiments.

FIG. 4 is a diagram illustrating a process for fabricating a waveguide workpiece with one or more optical features using non-selective deposition of an NIL layer in accordance with some embodiments.

FIG. 5 is a diagram illustrating a process for fabricating a waveguide workpiece with one or more optical features using selective deposition of an NIL layer in accordance with some embodiments.

FIG. 6 is a diagram illustrating an optical device having a waveguide with a NIL layer having core-shell nanoparticles that is disposed between a first transparent body and a second transparent body in accordance with some embodiments.

FIG. 7 is a diagram illustrating a rear perspective view of a set of AR glasses with at least one lens employing a waveguide with an NIL layer having core-shell nanoparticles in accordance with some embodiments.

### DETAILED DESCRIPTION

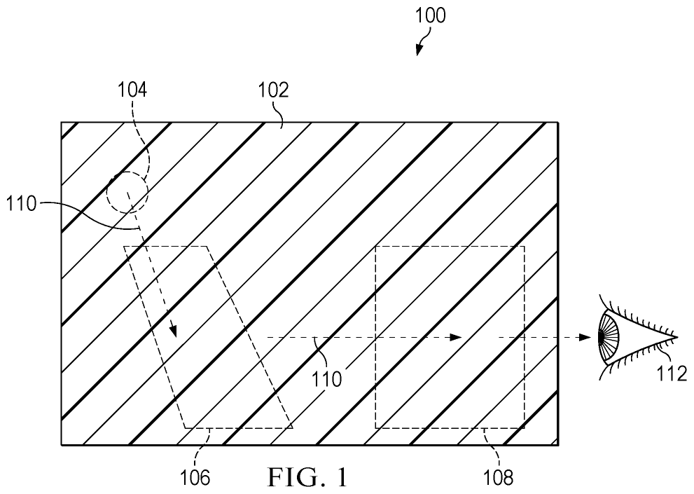

FIGS. 1-7 illustrate example systems and methods of utilizing NIL materials in diffractive waveguides for enhanced light stability or other benefits. A waveguide component in AR devices is an optical element that operates to direct and guide light within the device. Diffractive waveguides use microscopic two-dimensional or three-dimensional features to diffract light and create virtual images. Utilizing core-shell nanoparticle-based NIL materials in diffractive waveguides as described herein improves the stability of light transmission in augmented reality devices. This involves incorporating nanoparticles into the waveguide's material composition.

The disclosed systems and methods of utilizing core-shell nanoparticle-based NIL materials in diffractive structures of a waveguide further includes incorporating a polymer resin containing core-shell nanoparticles to withstand light-induced aging. This light may encompass one or both of environmental lighting (e.g., solar radiation or artificially-generated external lighting) or emitted light from a light source such as a light engine. The nanoparticles in NIL materials may include, but not be limited to, a metal core, for instance, titanium dioxide, along with ligands that facilitate their solubility and stability. In certain instances, the metal core may be doped with another metal such as aluminum. In an embodiment, a thin layer of a metal, such as zirconium dioxide, may be disposed as a shell overlapping and/or covering the metal core, thus influencing the properties of the nanoparticle. The use of core-shell nanoparticles may be applicable to various combinations of metal-core and metal-shell embodiments. The core provides specific optical properties, while the shell adds additional functionality and maintains stability of the nanoparticle.

FIG. 1 illustrates a waveguide 100 suitable for utilizing NIL materials for improved light stability and/or other reasons in accordance with embodiments. To address this, a nanoparticle-infused NIL material layer 102 may be applied to one or both sides of the waveguide to provide a protective measure. The waveguide 100 includes an IC 104, an optional EPE 106, and an OC 108. The IC 104 is configured to receive display light 110 from a light engine (not shown) and/or another light source. In configurations that include an EPE, the EPE 106 is configured to increase the size of the display exit pupil. The position of the IC 104 typically is tied to the position of the EPE 106; that is, the IC 104 is aligned with EPE 106. In other words, they are adjusted and aligned in a way that facilitates the smooth transition of light from one component to the other. The OC 108 is configured to direct the resulting display light 110 toward a user's eye 112. This combination of components operates together for the display light to reach the user's eye in the intended manner.

A waveguide component of AR devices, such as smart glasses, headsets, and smartphone applications utilize the device's camera and screen to deliver augmented experiences. These devices find applications in fields including gaming, education, navigation, and various industries for tasks such as remote assistance, training, and visualization to name a few. The layers, structures, and materials constituting optical components like the IC, EPE, and OC may experience degradation when exposed to high-intensity light. This degradation often arises from phenomena such as photochemical reactions, thermal effects, and alterations in material properties induced by photon absorption. For instance, the IC, tasked with coupling light into the waveguide, may undergo changes in its optical characteristics due to prolonged exposure to intense light. Similarly, the EPE, designed to expand the light beam, and the OC, responsible for extracting light from the waveguide, may encounter issues related to thermal stress and optical degradation under intense illumination.

The nanoparticle-infused NIL material layer 102 can serve one or more purposes. For example, the nanoparticle-infused NIL material layer 102 may act as a barrier against photochemical reactions, enhance thermal stability, modify the optical properties of the surface, and the like. The nanoparticles, integrated into the coating, may contribute to the durability of the optical components by absorbing and/or dispersing incident light, thereby reducing the impact of photon-induced processes. This NIL layer strategy, with its nanoparticle characteristics and nanoimprint lithography application, serves as a solution to mitigate the detrimental effects of light exposure, to facilitate the longevity and performance of optical elements in various applications. Some of these nanoparticles are described in detail below.

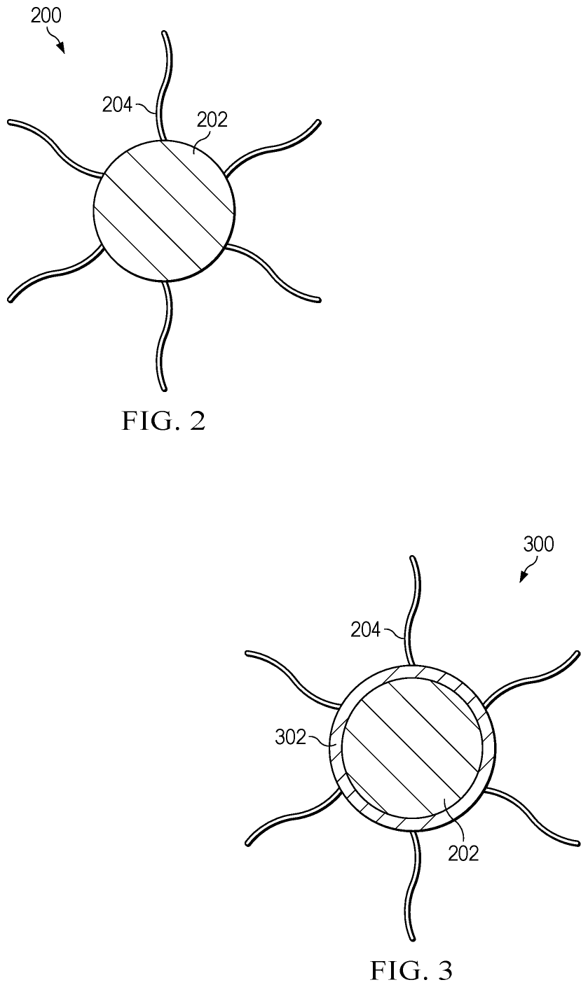

Turning now to FIGS. 2 and 3, two examples of nanoparticles that may be utilized in a nanoparticle-infused NIL material layer 102 for the waveguide 100 are described. In particular, these example nanoparticles employ features that help ensure their stability during use, as opposed to conventional NIL materials. FIG. 2 illustrates a nanoparticle 200 that may be beneficial for use in the nanoparticle-infused NIL material layer 102 of the waveguide 100. The nanoparticle 200 is composed of a metal core 202 and a plurality of ligands 204 connected thereto. Ligands 204 are molecules or ions that are attached to the surface of the metal core of nanoparticles. These ligands 204 stabilize the nanoparticles and may enhance their solubility in the surrounding medium. The ligands 204 form a protective layer around the metal core 202, preventing aggregation or clumping of nanoparticles 200 and facilitate their dispersion in the nanoparticle-infused NIL material layer 102. Examples of materials used in the metal core 202 may include, but not limited to, titanium dioxide, barium titanate, indium oxide, niobium oxide, silicon nitride, vanadium oxide, zirconium titanate oxides, cerium oxide, and/or among others. These nanoparticles may have different shapes, including spherical and/or cylindrical orientations.

The stabilization and enhanced solubility of nanoparticles by the ligands 204, as described in FIG. 2, involve molecular interactions. The ligands 204, represented by molecules or ions, attach themselves to the surface of the metal core of nanoparticles, forming ligand-nanoparticle complexes. This attachment is not merely physical; it often involves chemical bonding between the ligands 204 and the metal surface. The ligands 204 facilitate the stabilization of the nanoparticles by forming a protective layer around the metal core 202. This protective layer shields the nanoparticles from external forces and interactions, preventing aggregation or clumping. The stabilization effect arises from the ability of the ligands 204 to create a steric hindrance or repulsive forces between adjacent nanoparticles. This impedes the close approach of nanoparticles and mitigates the attractive forces that could lead to aggregation.

Furthermore, the ligands 204 contribute to facilitate the solubility of nanoparticles in the surrounding medium. The chemical nature of the ligands 204 and their interactions with the medium influence the dispersion behavior of nanoparticles. Ligands 204 may alter the surface properties of nanoparticles, making them more compatible with the surrounding medium, which is exploited in the context of the NIL polymer resin layer. This enhanced solubility facilitates the dispersion of nanoparticles in the material. The ligands function as molecular stabilizers by creating a protective layer around the nanoparticles, preventing undesirable interactions that could compromise their stability. The chemical nature of the ligands 204 and their attachment to the metal core 202 contribute to the solubility enhancement of nanoparticles and their dispersion in the nanoparticle-infused NIL material layer 102 of the waveguide.

FIG. 3 illustrates a core-shell nanoparticle 300 composed of a metal core 202, a metal shell 302, and a plurality of ligands 204 connected thereto. The material for metal shell 302 may include, but not be limited to, any metal that is compatible with the core metal. As a result of this compatibility the properties of the nanoparticles may be altered to have desirable functionalities. For example, when employing NIL materials containing core-shell nanoparticles in diffractive waveguides, an enhanced light stability may result. In an embodiment, alongside these core-shell nanoparticles, the NIL material may incorporate various components such as monomers, oligomers, photo initiators, and supplementary additives. The monomers and oligomers encompass substances such as, acrylate, epoxy, epi-sulfide, urethane, and other reactive end-group functionalities typically utilized in UV-initiated polymerizations.

In an embodiment, when employing core-shell nanoparticles, featuring for example, a titanium-dioxide core, encased by a thin layer of zirconium dioxide along with a plurality of ligands, extending therefrom, for solubilization and stabilization, diffractive waveguides may exhibit enhanced light stability. This translates to the preservation, for example, during and post light exposure. Notably, these improvements may manifest as reduced color-shifting, diminished transmission loss, mitigated haze increase, limited refractive index alterations, and/or controlled film thickness adjustments, all of which are factors that may otherwise compromise waveguide performance.

In some embodiments, each nanoparticle of the plurality of nanoparticles has a size of about 50 nanometers (nm) to about 700 nm. In some embodiments, each nanoparticle of the plurality of nanoparticles having a size of about 2 nanometers (nm) to about 50 nm. In some embodiments, the plurality of nanoparticles comprising a metal core composed of a first metal material and plurality of ligands disposed on at least a portion of the metal core.

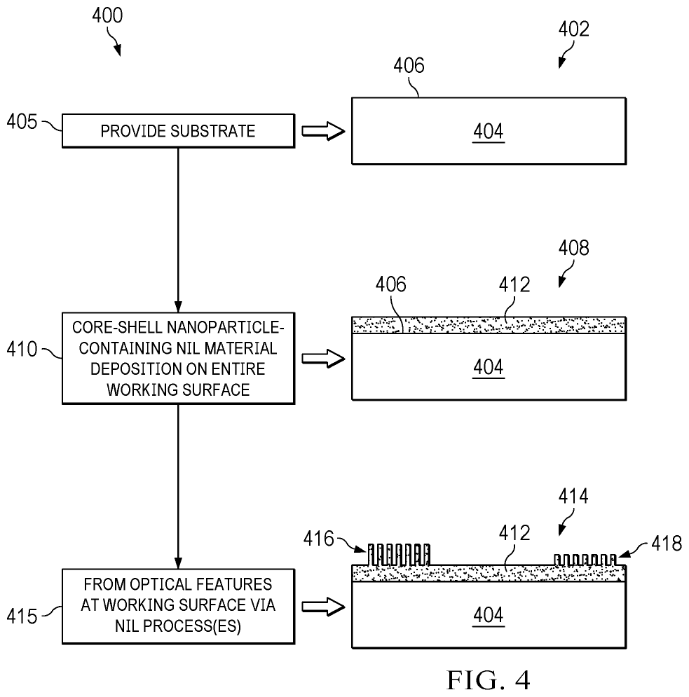

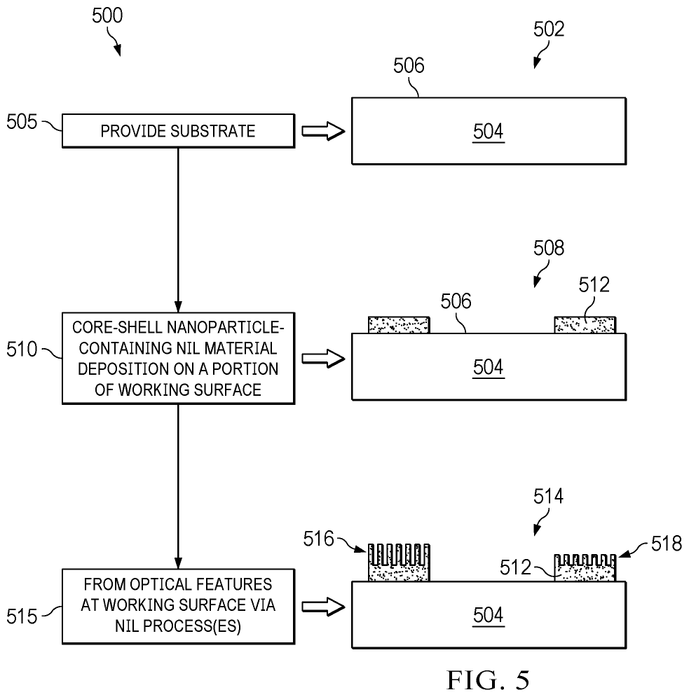

Referring now to FIGS. 4-5, two fabrication methods, employed to create a waveguide such as waveguide 100 in FIG. 1, involve depositing a layer of polymer resin onto the substrate surface of the waveguide, incorporating a multitude of nanoparticles. Notably, the waveguide comprises diffractive optical components formed from the nanoparticle-infused NIL material layer. FIG. 4 illustrates a method 400 for fabrication of a waveguide (such as waveguide 100, FIG. 1) utilizing at least one NIL layer employing nanoparticles with ligands in accordance with embodiments. At block 405, a waveguide workpiece 402 composed of a substrate 404 is provided. The substrate 404 may comprise any of a variety of suitable materials, such as a monolithic block of polymer or one or more bonded layers of polymers, a monolithic block of glass or one or more bonded layers of glass, or a combination thereof. The substrate 404 has a working surface 406. In other embodiments, the substrate 404 also has an opposing second working surface. At block 410, a deposition process is performed to coat the working surface 406 with a NIL material that contains core-shell nanoparticles, such as the nanoparticle 200 of FIG. 2 and/or the core-shell nanoparticle 300 of FIG. 3, resulting in a waveguide workpiece 408 having an NIL material layer 412 disposed at the working surface 406. As described herein, the NIL material layer 412 may be composed of, for example, a polymer resin in which one or more types of core-shell nanoparticles are suspended. The deposition process for forming the NIL material layer 412 may include, for example, inkjet, spin coating, or chemical vapor deposition (CVD).

In an example CVD process, the substrate, potentially the surface of the waveguide, is prepared for deposition. The precursor chemicals for the polymer resin and core-shell nanoparticles are introduced into the reaction chamber, and the deposition takes place in a controlled environment. During the deposition, the precursor molecules undergo chemical reactions on the substrate's surface. The polymer resin is formed as a thin film, and the core-shell nanoparticles become integrated into this growing film. The controlled reaction conditions, such as temperature and pressure, ensure the precise formation of the desired coating. The core-shell nanoparticles, with their metal core and ligand shell, are incorporated into the polymer matrix during the deposition process. The uniformity and thickness of the coating are regulated by the deposition parameters and may be monitored in real-time. After the deposition is complete, the coated substrate may undergo additional processing steps, such as curing or annealing, to enhance the stability and optical properties of the coating.

In another example, the implementation of nanoparticles in a NIL layer involves nanoparticles chosen based on specific properties aligned with the coating's desired characteristics, considering factors like optical, thermal, or mechanical performance. These nanoparticles undergo synthesis through precise methods, ensuring controlled size, shape, and composition. The coating material, typically a polymer or substance for nanoimprint lithography, is then prepared. The synthesized nanoparticles are uniformly dispersed within this material, utilizing techniques such as ultrasonication or mechanical mixing for even distribution. Surface treatments or functionalization may be applied to stabilize the dispersion, preventing nanoparticle agglomeration, and to facilitate stability. Integration into the nanoimprint lithography process follows, involving the application of the nanoparticle-infused coating onto the substrate through methods like spin coating or dip coating. Nanoimprint lithography is then employed to imprint nanoscale patterns onto the coated material using a template. Subsequent curing or solidification fixes the nanoparticle-infused NIL layer onto the substrate, ensuring stability and integrity. The final step involves thorough characterization to verify the desired nanoparticle distribution and properties. The process, from nanoparticle selection to nanoimprint lithography optimization, is conducted to tailor the coating for one or both sides of the waveguide. This implementation enhances the waveguide's durability and performance under optical conditions through the integration of nanoparticles into the nanoimprint lithography coating.

At block 415, one or more other NIL processes are employed to form various optical features in, at, and/or above the NIL material layer 412, resulting in a waveguide workpiece 414. Such NIL processes may include, for example, a step-and-flash imprint lithography technique. In this process, a template or mold, containing the desired nanoscale patterns for the optical features, is brought into contact with the NIL material layer 412. The template is often a transparent material with relief patterns on its surface corresponding to the optical structures required in the waveguide. The contact is carefully controlled to ensure proper alignment and uniformity. Upon contact, the NIL material layer 412 undergoes deformation and replicates the nanoscale patterns from the template. This step is often referred to as the “imprint” step. UV-light in this step cures the material and the hardened material takes the shape of the template, forming the desired optical structures. Following the imprint step, the template is separated from the NIL material layer 412, leaving behind the imprinted patterns. This separation, or “demolding” step, needs to be carefully executed to avoid damaging the newly formed optical features. The result is a waveguide workpiece 414 with optical structures in, at, and/or above the NIL material layer 412 which may be advantageous for the fabrication of waveguides where nanoscale optical features are configured to guide and manipulate light.

Some optical features formed may include, for example, diffractive features forming one or more of an IC, an EPE, an OC, and the like. For example, a set 416 of diffractive gratings may be formed during an NIL process so as to form an IC for the waveguide workpiece 414, and a different set 418 of diffractive gratings may be formed during the same or different NIL process so as to form an OC for the waveguide workpiece 414. FIG. 4 has described a method for nanoparticle-infused NIL material deposition on an entire working surface. Referring now to FIG. 5, another embodiment describes a method for nanoparticle-infused NIL material deposition on a portion of a selective working surface.

FIG. 5 illustrates a method 500 for fabrication of a waveguide (such as waveguide 100, FIG. 1) utilizing at least one NIL layer employing nanoparticles with ligands in accordance with embodiments. At block 505, a waveguide workpiece 502 composed of a substrate 504 is provided. The substrate 504 may comprise any of a variety of suitable materials, such as a monolithic block of polymer or one or more bonded layers of polymers, a monolithic block of glass or one or more bonded layers of glass, or a combination thereof. The substrate 504 has a working surface 506. In other embodiments, the substrate 504 also has an opposing second working surface. At block 510, a deposition process is performed to coat the working surface 506 with a NIL material that contains core-shell nanoparticles, such as the core-shell nanoparticle 200 of FIG. 2 and/or the core-shell nanoparticle 300 of FIG. 3, resulting in a waveguide workpiece 508 having an NIL material layer 512 disposed at the working surface 506. As described herein, the NIL material layer 512 may be composed of, for example, a polymer resin in which one or more types of core-shell nanoparticles are suspended.

At block 515, one or more other NIL processes are employed to form various optical features in, at, and/or above the NIL material layer 512, resulting in a waveguide workpiece 414. Such NIL processes may include, for example, a step-and-flash imprint lithography technique. In this process, a template or mold, containing the desired nanoscale patterns for the optical features, is brought into contact with the NIL material layer 512. The template is often a transparent material with relief patterns on its surface corresponding to the optical structures required in the waveguide. The contact is carefully controlled to ensure proper alignment and uniformity. Upon contact, the NIL material layer 512 undergoes deformation and replicates the nanoscale patterns from the template. This step is often referred to as the “imprint” step. UV-light in this step cures the material and the hardened material takes the shape of the template, forming the desired optical structures. Following the imprint step, the template is separated from the NIL material layer 512, leaving behind the imprinted patterns. This separation, or “demolding” step, needs to be carefully executed to avoid damaging the newly formed optical features. The result is a waveguide workpiece 514 with optical structures in, at, and/or above the NIL material layer 512 which may be advantageous for the fabrication of waveguides where nanoscale optical features are configured to guide and manipulate light.

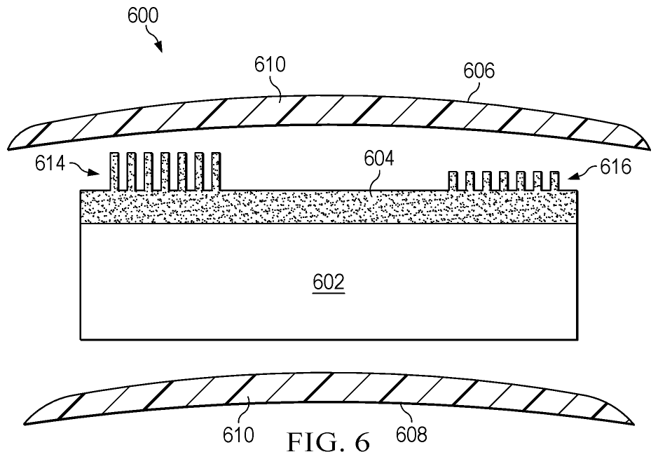

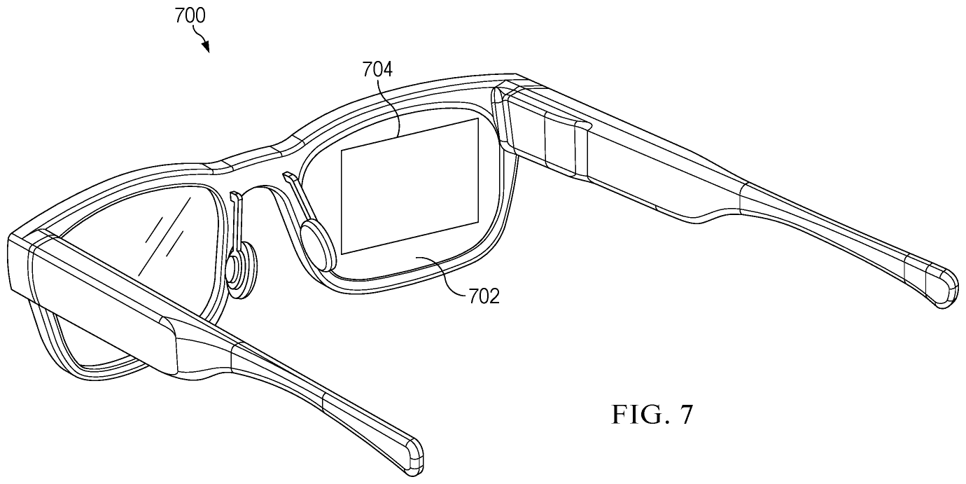

Some optical features formed may include, for example, diffractive features forming one or more of an IC, an EPE, an OC, and the like. For example, a set 516 of diffractive gratings may be formed during an NIL process so as to form an IC for the waveguide workpiece 514, and a different set 518 of diffractive gratings may be formed during the same or different NIL process so as to form an OC for the waveguide workpiece 514. FIG. 5 has described a method for nanoparticle-infused NIL material deposition on a portion of a selective working surface. Referring now to FIG. 6, a combination approach to waveguide construction includes the methods of FIG. 4 or 5 with UV blocking lenses facing the world-side and eye-side is further described.

FIG. 6 illustrates an optical device 600 having a waveguide workpiece 602 employing at least one nanoparticle-infused NIL material layer 604 in accordance with some embodiments. As depicted, the waveguide workpiece 602, which may be formed using, for example, either the method 400 of FIG. 4 or the method 500 of FIG. 5, includes the waveguide workpiece 602 positioned between a first transparent body 606 and a second transparent body 608. For example, the optical device 600 may comprise a lens for use in a set of AR glasses or other AR device, such that the first transparent body 606 comprises a world-side lens and the second transparent body 608 comprises an eye-side lens, with the waveguide workpiece 602 disposed therebetween and configured to transport display light from a light engine (not shown) toward the eye of a wearer of the AR device via the second transparent body 608 while allowing light from the real world environment that is incident on the first transparent body 606 to transmit through the optical device 600 toward the user's eye, thereby causing light from the real world environment and display light from the light engine to be overlaid and perceived by the eye together.

In an embodiment, a UV light absorbing material 610, such as a UV light absorbing material may be disposed on and/or integrally formed within waveguide workpiece 602, first transparent body 606, and/or second transparent body 608 within an optical device 600 such as an augmented reality device. The UV light absorbing material 610 may be integrally formed within the nanoparticle-infused NIL material layer 604. In an embodiment, waveguide workpiece 602 has diffractive optical elements such as diffractive gratings that may be formed during an NIL process so as to form an IC 614 and a different set of diffractive gratings may be formed during the same or different NIL process so as to form an OC 616 on waveguide workpiece 602. In an embodiment, the employed in conjunction with UV light absorbing material 610 positioned on both sides of the waveguide workpiece 602. This configuration may enhance resilience of waveguide workpiece 602 against light-induced damage.

UV light-absorbing materials 610 may include a range of compounds designed to absorb ultraviolet radiation. For example, organic UV absorbers, such as benzotriazoles and benzophenones, have molecular structures capable of absorbing specific UV wavelengths. In another example, inorganic UV absorbers, such as zinc oxide and titanium dioxide, exhibit UV-blocking properties due to their electronic structures. Further, certain polymers inherently possess UV-absorbing capabilities; for instance, certain formulations of polyethylene or polypropylene may act as effective UV absorbers. Carbon-based materials, including carbon black and graphene, absorb UV radiation and dissipate the absorbed energy through various mechanisms. Dyes and pigments may be engineered to absorb UV light are employed in coatings and films. Nanoparticles, such as zinc oxide or cerium oxide nanoparticles, contribute to UV absorption when dispersed within materials. These UV light-absorbing materials may be selected based on factors such as the wavelength range of UV light to be absorbed, compatibility with the optical system, and the intended application for performance and protection in complex optical devices and systems.

FIG. 7 illustrates a set of AR glasses implementing a waveguide having one or both major surfaces with a NIL layer having one or more types of core-shell nanoparticles formed via one or more of the processes described above. As shown, the AR glasses 700 include a set of lenses, including a lens 702 incorporating a waveguide 704. The waveguide 704 can incorporate optical features fabricated in an NIL layer as described above, such as for an incoupler, an outcoupler, or some other optical component of the waveguide.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method for forming a diffractive waveguide, comprising:
providing a waveguide substrate having a first working surface;
disposing a polymer resin layer having a plurality of nanoparticles at one or more portions of the first working surface of the waveguide substrate, and
wherein the plurality of nanoparticles comprises:
a metal core composed of a first metal material; and
a plurality of ligands disposed on at least a portion of the metal core; and
implementing one or more optical features at the polymer resin layer.

2. The method of claim 1, further comprising:
forming a lens by disposing the waveguide substrate between a first transparent body and a second transparent body.

3. The method of claim 2, wherein
the first transparent body and the second transparent body are composed of an ultraviolet (UV) light absorbing material.

4. The method of claim 1, wherein the one or more optical features are diffractive optical components.

5. The method of claim 4, wherein the diffractive optical components form at least one of: an input coupler, an exit pupil expander, or an output coupler.

6. The method of claim 1, further comprising:
disposing the polymer resin layer having the plurality of nanoparticles at one or more portions of a second working surface of the waveguide substrate, and
wherein the second working surface is located opposite the first working surface.

7. The method of claim 1, wherein the plurality of nanoparticles each has a size of about 50 nanometers (nm) to about 100 nm.

8. The method of claim 1, wherein the plurality of nanoparticles each has a size of about 2 nanometers (nm) to about 50 nm.

9. The method of claim 1, wherein a surface of the metal core has a metal shell formed thereon.

10. A method for forming a diffractive waveguide, comprising:
providing a waveguide substrate having a first working surface;
implementing one or more optical features at one or more portions of the first working surface of the waveguide substrate;
disposing a polymer resin layer having a plurality of nanoparticles on the one or more optical features, and
wherein the plurality of nanoparticles comprise:
a metal core composed of a first metal material; and
a plurality of ligands disposed on at least a portion of the metal core.

11. An optical device, comprising:
a waveguide comprising:
a transparent substrate having a polymer resin layer with a plurality of nanoparticles disposed at one or more portions of a first working surface of a substrate, wherein the nanoparticles of the plurality of nanoparticles each comprises: a metal core composed of a first metal material and a plurality of ligands disposed on at least a portion of the metal core;
one or more optical components implemented at least partially in the polymer resin layer.

12. The optical device of claim 11, wherein the one or more optical components comprises at least one of an input coupler, an exit pupil expander, or an output coupler.

13. The optical device of claim 11, wherein the plurality of nanoparticles each has a size of about 50 nanometers (nm) to about 100 nm.

14. The optical device of claim 11, wherein the plurality of nanoparticles each has a size of about 2 nanometers (nm) to about 50 nm.

15. The optical device of claim 11, wherein the plurality of nanoparticles each has a size of about 5 nanometers (nm) to about 20 nm.

16. The optical device of claim 11, further comprising:
one or more portions of a second working surface of the waveguide substrate having a polymer resin layer having a plurality of nanoparticles, and
wherein the second working surface is located opposite the first working surface.

17. The optical device of claim 16, further comprising:
a metal shell disposed on a surface of the metal core.

18. The optical device of claim 16, wherein the metal core is composed of a second material.

19. The optical device of claim 11, wherein the polymer resin layer has an ultraviolet (UV) light absorbing material.

20. The optical device of claim 11, wherein the transparent substrate has the polymer resin layer with the plurality of nanoparticles adjacent to a second surface of the substrate.
